(19) United States
(12) Patent Application Publication
(10) Pub. No.: US 2006/0181393 A1
(43) Pub. Date: Aug. 17, 2006

(54) Method and corresponding system for hand-held rf tag locator

(76) Inventor: Dan Raphaeli, Kfar Saba (IL)

Correspondence Address: Mark M Friedman;Polkinghorn, 9003 Florinway, Upper Marlboro, MD, 20772, US

(21) Appl. No.: 10/565,846

(22) PCT Filed: Jul. 27, 2004
(86) PCT No.: PCT/IL04/00688

§ 371 Date: Jan. 26, 2006

Related U.S. Application Data
(60) Provisional application No. 60/490,537, filed on Jul. 29, 2003.

(51) Int. Cl. H04Q 5/22

(52) U.S. Cl. 340/10.1; 340/825.49

(57) ABSTRACT

A method and system for a hand-held RF tag locator (6) featuring the unique method of locating the position of one or more RF tags (4) by using a directional antenna (8) enabling azimuth determination and measuring the round trip delay enabling distance determination between the hand-held RF tag (6) locator to the RF tags (4).

### FIELD AND BACKGROUND OF THE INVENTION

The present invention relates to hand-held radio frequency (RF) tag locator, and more particularly, to a method and a corresponding system for a hand-held RF tag locator featuring the unique method of locating the position of one or more RF tags by using a directional antenna enabling azimuth determination and measuring the round trip delay enabling distance determination between the hand-held RF tag locator to the RF tags.

RF identification (RFID) systems are used to track objects, animals and/or people in a large range of applications. RFID systems are radio communication systems that communicate between a radio transceiver, called a reader, and a number of inexpensive devices called Tags. An RFID system generally includes a plurality of tags which are attached to objects being monitored and one or more readers which are used to communicate with those tags. An encoder is optionally used to program the tags with unique identification information.

Basic principles and details relating to radio frequency (RF) wireless identification systems needed for properly understanding the present invention are provided herein. Complete theoretical descriptions, details, explanations, examples, and applications of these and related subjects are readily available in standard references in the fields of radio frequency identification (RFID) systems, and in particularly in PCT application No. PCT/IL 03/00358, dated May 4, 2003, by the same inventor of the present invention, the teachings of which are incorporated by reference as if fully set forth herein.

In PCT application No. PCT/IL 03/00358, dated May 4, 2003, there is disclosed a method and a system for communicating between a RF reader and one or more terminal stations referred to hereinafter as ‘tags’, comprising the steps of: (a) transmitting an interrogation radio frequency (RF) signal, by the reader; (b) receiving from a plurality of terminal stations, on a single channel, a plurality of RF response signals generated responsive to the interrogation signal; (c) determining, for the plurality of the received response signals, a round trip delay from the transmission of the interrogation signal to the reception of the response signals; (d) determining, for each of the response signals, a distance between the reader and the terminal station from which the response signal was received, according to the determined round trip delay of the response signal.

In U.S. Pat. No. 6,335,685, issued to Schrott el al, there is disclosed an apparatus and method for locating containers and contents of containers using radio frequency tags. A base station system for communicating with radio frequency tags attached to one or more objects. The base station has computers having CPUs and memories. A separate position detector determines the position of the tags within a time increment and within a field of the base station. A communication process, executed by the CPUs, reads information from the tags within the time increment and associates the position determined with the information of the respective tag in the memories. The method features a movable base station antenna providing a narrow tag interrogation beam is used as the position detector. The antenna of the reader is designed to have rotational motion to allow for scanning in a vertical plane. Scanning accomplished as a function of position with the antenna scanning vertically while the object moves horizontally. In that mode of scanning, each tag is scanned individually as it passes the base station antenna so that the combination of horizontal object motion with vertical scanning results in a [x, y] coordinate associated with each tag readout. The horizontal motion can be determined by knowing the velocity of the object.

However, the just described method suggesting using a separate position detector to detect the position of the tag identified by the reader is notably limited because it adds to the cost and complexity of the RFID system. In addition, the position detection is performed after the tags are identified in a separate stage, which adds to the time required for the system operation.

To date, the inventor is unaware of prior art teaching of a method and system for a hand-held RF tag locator featuring measuring the round trip delay and acquiring directional information by using a directional antenna.

There are many situations where a user has to locate an object in a short time, either for convenience or for emergency. In particular there is a problem to locate a car in a large parking lot. The common technique used today to find an object or a car is sending a signal, usually using RF frequency, and a receiver attached or inside that object activates some attention attracting functions, mostly audibly or visually. Whenever the item is sufficiently far away, or obstructed, or in tough weather, such signaling is not reliable and/or not practical. Moreover, depending on the application, making noise or attracting attention may not be desirable. There is thus a need for, and it would be highly useful to have a method and a system for a hand-held RF tag locator featuring measuring the round trip delay and acquiring directional information. The present invention accomplishes that need by using a directional antenna and measuring the Round Trip Delay (RTD). Furthermore, there is a need for such a method and a system for a hand-held RF tag locator that is providing the location information in or by that hand held locator so that hearing or seeing the target is not required, allowing operation in larger distances and more conveniently.

Moreover, there is a need for such a method which is significantly simpler for operating, more rapid, than currently used techniques for locating RF tags, based on transmitting a signal to the tag, and the tag as response makes a tone/beep or in case of cars blinks the head lights and play the horn.

### SUMMARY OF THE INVENTION

The present invention relates to hand-held RF tag locator, and more particularly, to a method and a corresponding system for a hand-held RF tag locator featuring the unique method of locating the position of one or more RF tags by using a directional antenna enabling azimuth determination and measuring the round trip delay enabling distance determination between the hand-held RF tag locator to the RF tags.

Thus, according to the present invention, there is provided a method and a corresponding device for locating a RF tag, featuring the unique method of locating the position of one or more RF tags by using a directional antenna enabling azimuth determination and measuring the round trip delay enabling distance determination between the hand-held RF tag locator to the RF tags, including the steps of (a) programming a locating device with an identification number of the RF tag, (b) transmitting a directional transmit command signal to said RF tag by using the locating device, wherein the locating device including a directional antenna, (c) the RF tag is waiting to receive the transmit command signal, (d) receiving the transmit command signal, by the RF tag, and transmitting, by the RF tag, at least one response signal in synchronization with the transmit command signal, and (e) receiving the at least one response signal, by the locating device, and measuring round trip delay and amplitude of the at least one received response signal.

According to still further features in the described preferred embodiments, the method and a corresponding device for locating a RF tag further includes the directional transmit command signal is directional wide band transmit command signal and said response signal is wide band response signal.

According to still further features in the described preferred embodiments, the method and a corresponding device for locating a RF tag further includes the directional wide band transmit command signal is unicast directional wide band transmit command signal.

According to still further features in the described preferred embodiments, the method and a corresponding device for locating a RF tag further includes the step of displaying the measured round trip delay and amplitude of the at least one received response signal on a display controller.

According to still further features in the described preferred embodiments, the method and a corresponding device for locating a RF tag further includes the step of delivering the measured round trip delay and amplitude of the at least one received response signal to an operating system, wherein the operating system is operating the locating device.

Implementation of the method and system for hand-held RF tag locator of the present invention involves performing or completing selected tasks or steps manually, semi-automatically, fully automatically, and/or, a combination thereof. Moreover, according to actual instrumentation and/or equipment used for implementing a particular preferred embodiment of the disclosed method and system, several selected steps of the present invention could be performed by hardware, by software on any operating system of any firmware, or a combination thereof. In particular, as hardware, selected steps of the invention could be performed by a computerized network, a computer, a computer chip, an electronic circuit, hard-wired circuitry, or a combination thereof, involving a plurality of digital and/or analog, electrical and/or electronic, components, operations, and protocols. Additionally, or alternatively, as software, selected steps of the invention could be performed by a data processor, such as a computing platform, executing a plurality of computer program types of software instructions or protocols using any suitable computer operating system.

### BRIEF DESCRIPTION OF THE DRAWINGS

The present invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. In the drawings:

FIG. 1 is a block diagram illustrating an exemplary preferred embodiment of the hand-held system for RF tag locating in accordance with the present invention;

FIG. 2 is a schematic time chart illustrating an exemplary preferred embodiment of a wide band transmit command signal, in accordance with an exemplary embodiment of the present invention;

FIG. 3 is a schematic block diagram illustrating an exemplary preferred embodiment of directional antenna 8, reader 2 and display controller 10, in accordance with an exemplary embodiment of the present invention; and

FIG. 4 (prior art) is a schematic block diagram illustrating an exemplary preferred embodiment of a tag, in accordance with an exemplary embodiment of the present invention;

### DESCRIPTION OF THE PREFERRED EMBODIMENTS

The present invention relates to hand-held RF tag locator, and more particularly, to a method and a corresponding system for a hand-held RF tag locator featuring the unique method of locating the position of one or more RF tags by using a directional antenna enabling azimuth determination and measuring the round trip delay enabling distance determination between the hand-held RF tag locator to the RF tags.

The system and method of the present invention are based on the novel cooperative operation of a RF tag, a directional antenna, a reader, a display controller, and a display device. The reader is sending a unicast message to a RF tag by using the directional antenna. The RF tag is transmitting an answer in synchronization with the reader. The reader is receiving the transmission from the RF tag and is measuring the round trip delay and the amplitude of the received radio signal. The display controller is receiving from the reader the measured round trip delay and amplitude of the radio signal, and displaying that information on a display device to the user.

Hereinafter, the term ‘channel’ refers to an allocation of resources providing a link between a transmitter and a receiver, Exemplary channels are frequency band, time slot, space direction and spreading code.

Hereinafter, the term ‘wide band signals’ or the equivalent term ‘spread spectrum signals’ refers to any spread spectrum signals types such as: direct sequence (DS), frequency-hopping (FH), multi-carrier CDMA, chirp signals, short or long pulses of any shape with or without time hopping.

Hereinafter, the term ‘signal’ refers to one signal or to a plurality of signals transmitted in one logical transmission period.

Hereinafter, the term ‘display device’ refers to any output form for interfacing results of a measurement such as: visual audio, sense, whatever.

It is to be understood that the present invention is not limited in its application to the details of the order or sequence of steps of operation or implementation of the method and system set forth in the following description, drawings, or examples. For example, step (b) may be separated to sub steps in order to transmit less information in each transmission.

Moreover, the method and corresponding system of the present invention can be implemented in a variety of configurations, for example, the functionality of the display controller and display device may be implemented in one integrated display and control device.

Additionally, for better understanding the overall general method of the present invention, the description provided herein disclosed an implementation of a handheld device communicating with one RF tag. However, it is to be clearly understood that the overall general method of the present invention is extendable and applicable to a parallel mode of implementation for handheld device communicating with a plurality of RF tags.

The present invention is capable of other embodiments or of being practiced or carried out in various ways. Also, it is to be understood that the phraseology, terminology, and, notation, employed herein are for the purpose of description and should not be regarded as limiting.

In the following description of the method of the present invention, included are only main or principal steps needed for sufficiently understanding proper ‘enabling’ utilization and implementation of the disclosed method and system. Accordingly, descriptions of the various required or optional minor, intermediate, and/or, sub steps, which are readily known by one of ordinary skill in the art, and/or, which are available in the prior art and technical literature relating to hand-held RF wireless identification systems, are not included herein.

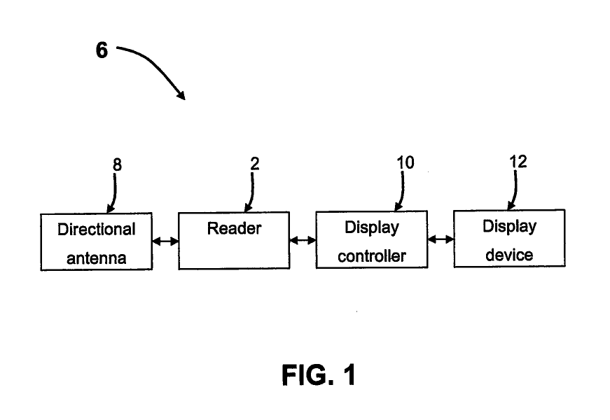

Referring now to the drawing, FIG. 1 is a block diagram illustrating an exemplary preferred embodiment of the hand-held device 6 for RF tag locating in accordance with the present invention, generally referred to as device 6. Device 6 features the following primary components: (a) directional antenna 8, (b) reader 2, (c) display controller 10, (d) display device 12. Each primary component, and additional components, needed for enabling the use of device 6 are described in the following detailed description of the method of the present invention.

In Step (a) of the method and corresponding system of the present invention, there is programming reader 2 with the identification number of a RF tag 4 to be located.

Hereinafter, the term “identification number” refers to any feature, number, characteristics, and/or identification means that can identify RF tag 4 to be located. For example, identification number (ID), serial number, known features of the tag, frequency, modulation, coding. Identification number can refers to a group of RF tags.

Reader 2 can be programmed with the identification number of RF tag 4 to be located by any appropriate input means supplying the identification of that RF tag 4. Few examples of that input means are: numeric pad, optical reader, RF receiver. Alternatively, reader 2 can be programmed with the identification number of RF tag 4 to be located by loading the identification number from a memory or by receiving the identification number from other methods of associating the reader and the tag prior to first usage. For example, the reader is programmed to find a predefined RF tag ID. In another example, while in configuration mode, the reader is receiving the ID of all tags in some range and is storing them in its memory. If there are several tags the reader is assigning serial numbers, such as tag #1, tag #2 and so on. Later the user will have the option either to display distance and direction information and/or indication for all assigned tags, or choose one using for example a small numeric pad.

In Step (b) there is reader 2 sending a wide band transmit command signal to RF tag 4 by using directional antenna 8.

In order to locate distance and directional information to one or more RF tags 4, reader 2 is sending a directional wide band transmit command signal to RF tag 4.

The reader may repeat its commands periodically, for example once a second, in order to continually track the tag. In order to save power of both the reader and the tag, the repetition frequency may be adaptive. The reader may increase the repetition frequency when it detects fast changes in the received power of the response, or make slower repetition when the received power of the response is stable.

In an exemplary embodiment of the present invention wherein reader 2 is displaying distance and directional information to a specific RF tag 4 having the identification number supplied in the previous step, reader 2 is sending an addressed wide band transmit command signal, known as unicast wide band transmit command signal. In another exemplary embodiment of the present invention wherein reader 2 is displaying distance and directional information to all recognized tags that had responded, or wherein reader 2 is displaying distance and directional information to tags matching a list of one or more tags associated to device 6 that had responded to reader 2 that sent a wide band broadcast transmit command signal. A wide band broadcast transmit command signal is a general signal, without a tag identification, that may or may not contain data. The wide band broadcast transmit command signal may contain the identification number of the reader, and the tags may not respond to unauthorized reader.

In an exemplary embodiment of the present invention, the transmission power of reader 2 may be configured by the user, for example to limit the range in which the signals are received. Such limitation may be used for security reasons and/or in order to limit the number of tags 4 responding to the wide band transmit command signal, and thus limit the chances of a collision occurring.

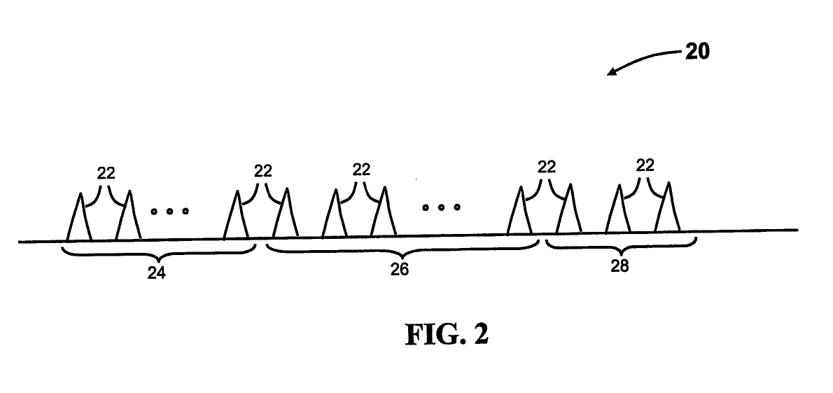

FIG. 2 is a schematic time chart illustrating an exemplary preferred embodiment of a wide band transmit command signal 20, in accordance with an exemplary embodiment of the present invention. Optionally, wide band transmit command signal 20 features a sequence of pulses 22 separated by a fixed interval, for example 10 microseconds (it is noted that for clarity of FIG. 2, the lengths of pulses 22 and the periods there-between are out of proportion). The pulses can be either unmodulated to generated base-band transmission, or modulated onto a carrier wave to generate pass-band transmission. Each pulse 22 optionally has a short duration of, for example, 10 ns (nanoseconds). In the preferred embodiment of the present invention, pulses 22 of wide band transmit command signal 20 are optionally organized in three intervals: a preamble portion 24, a data portion 26, and a response period portion 28. Each interval may not be fixed, but be used, either periodic or not periodic, according to some pseudo-random sequence in order to reduce the collision probability between two readers 2.

Preamble portion 24 is optionally used to alert tags 4 of the command. In an exemplary embodiment of the present invention, the number of pulses 22 in preamble portion 24 is such that tag 4 will be activated and receive at least one of pulses 22 of preamble portion 24, regardless of the relative timing of reader 2 and tag 4. Optionally, preamble portion 24 includes a sufficient number of pulses, such that a plurality of pulses 22, for example, at least five, will be available to be identified in activation periods by any tag 4, in case one or more of the pulses 22 is not identified due to noise or other reasons. In an exemplary embodiment of the invention, preamble portion 24 includes about 500 pulses 22.

In an exemplary embodiment of the invention, data portion 26 of wide band transmit command signal 20 features one or more of the following fields: a delimiter field, for identifying the beginning of the message (for example, 16 bits), a reader ID field (for example, 48 bits), a command field (for example, 8 bits), an optional information field (for example, 48 bits), a cyclic redundancy check (CRC) field (for example, 16 bits), and/or an error correction code (ECC) parity field (for example, 16 bits). It is noted that these fields and lengths are brought by way of example and any other suitable fields and/or sizes may be used with the present invention.

In an alternative exemplary embodiment of the present invention, in addition to a value representing the broadcast wide band transmit command signal 20, the command field may have other values, for example, a value representing the unicast wide band transmit command, followed by a tag ID field in the information field, for communication with a specific tag 4. Optionally, an authentication method, possibly a two-way authentication method, is used during the communication between reader 2 and a specific tag 4. Alternatively, an encryption method is used to prevent unauthorized eavesdropping.

Alternatively, a wide band transmit command signal 20 without modulation can be used in simple system with low requirements, and for systems not designed to discriminate between multiple concurrently operating readers.

Pulses 22 of response period portion 28 are optionally used by tags 4 to synchronize their response signals, as described hereinafter. Pulses 22 of data portion 26 are optionally modulated with specifics of the wide band transmit command signal 20, while pulses 22 of preamble portion 24 and response period portion 28 are not modulated, or modulated with a sequence known to the tags. In an alternative exemplary embodiment of the present invention, pulses 22 are modulated by changing their transmission time. For example, a ‘1’ bit may be modulated on to a pulse 22 by 5 ns delaying the transmission of a pulse, and a ‘0’ bit may be modulated by transmitting a pulse 5 ns in advance. Moreover, other modulation methods, for example, amplitude modulation, phase modulation, and/or frequency modulation schemes, may be used.

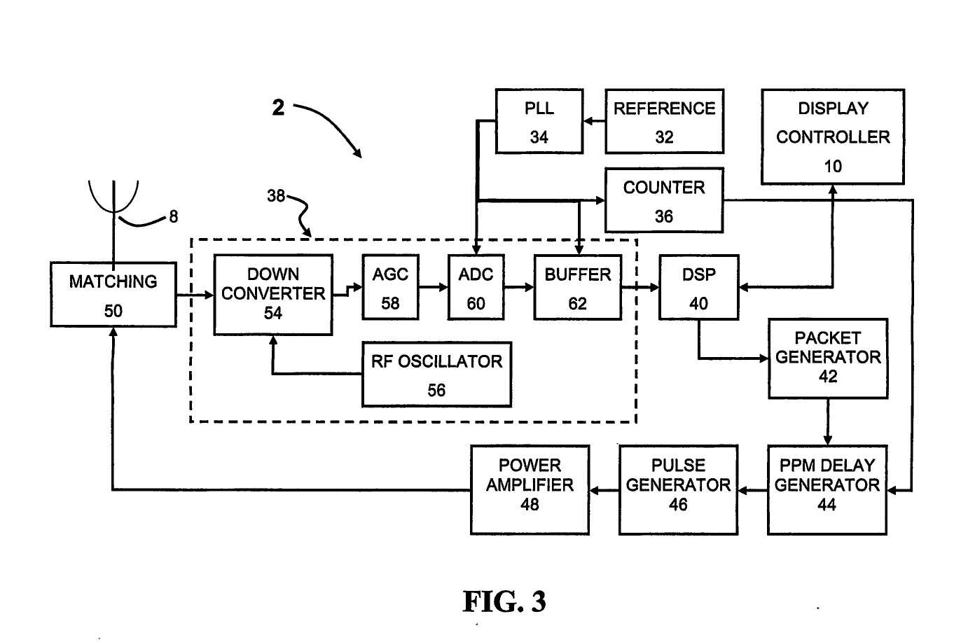

FIG. 3 is a schematic block diagram illustrating an exemplary preferred embodiment of directional antenna 8, reader 2 and display controller 10, in accordance with an exemplary embodiment of the present invention. A PLL 34 is controlled by a high frequency reference clock 32 providing a high frequency clock signal, for example 200 MHz with a 5 ns (nano second) cycle. Optionally, the clock cycle should be sufficient to sample the signal bandwidth according to Niquist criterion. A counter 36 optionally providing a low frequency signal (for example, 100 KHz) for timing the generation of pulses 22 (i.e., each low frequency signal initiates a transmission of a pulse 22). Packet generator 42 is generating the packet data of wide band transmit command signal 20. In an exemplary embodiment of the present invention, packet generator 42 providing the bits of the packet data to a pulse position modulation (PM) delay generator 44 substantially as described below with reference to tag 4. It is noted that packet generator 42 may provide three signals, i.e., for ‘0’, ‘1’ and no modulation. Similarly to that described with reference to tag 4, the output of generator 44 is provided to a pulse generator 46, which passes its output to a power amplifier 48 for transmission after impedance matching 50. In order to acquire directional information, the antenna of device 6 is a directional antenna 8. In a preferred embodiment of the present invention, the reader is using the frequency band of 2.4-2.48 GHz and the size of the antenna is about 5×5 cm. The side-lobes and back-lobe of directional antenna 8 should be kept small. An exemplary antenna in accordance with the present invention includes a metal back. In a preferred embodiment of the present invention, in order to make the size of device 6 smaller and more convenient to carry, the directional antenna can be folded whenever device 6 is not in use. Folded antennas are well known in the art. An exemplary reference is “Antenna Theory: Analysis and Design”, 2nd Edition, by Constantine A. Balanis.

The directional antenna can be ‘smart’ directional antenna or ‘Monopulse’ type configuration, conveying angle information as well by using at least two receiving antennas. These antennas have antenna patterns exhibiting a single mainlobe. The antennas are spatially separated on the order of a wavelength or more and their mainlobes are oriented in slightly different directions. The output signals of the antennas are processed by first the sum and difference signals of the two antenna signals. The sum signal corresponds to a beam pattern in the far field and is designated the sum beam. The difference signal corresponds to a beam pattern in the far field and is designated the difference beam. As is well known in the art of Monopulse radar, the angle of arrival of a signal can be estimated from comparison of the sum and difference beams.

Remaining components of reader 2 used for receiving the responses from tags 4 are described in step (e) of the method of the present invention.

In step (c) there is at least one tag 4 waiting to receive the wide band transmit command signal.

While tag 4 is waiting to receive the wide band transmit command signal, the tag is scanning in the time domain or scanning in the frequency domain especially whenever there is uncertainty in the frequency. RF tag 4 is transmitting only after receiving the transmit command from the reader, mainly in order to save energy, prevent spectral pollution, and enlarge the tag lifetime.

In an exemplary embodiment of the present invention, featuring tags 4 are scanning in the time domain, whenever tags 4 are not transmitting or receiving signals, they are deactivated into a sleep mode in order to conserve energy. Optionally, in the sleep mode, tags 4 are activated periodically with a duty cycle of, for example, 1%. In an exemplary embodiment of the invention, during the sleep mode, tags 4 are activated for about 100 ns every period of about 10 microseconds. Optionally, the time between activation periods of tags 4 is different than the time between consecutive pulses 22 of wide band transmit command signal, such that after up to a predetermined number of activation periods, an activation period will coincide with a pulse 22. Optionally, tags 4 include a high rate counter adapted to time the activation periods.

In an exemplary embodiment of the present invention featuring tags 4 scanning in the frequency domain, tags 4 are sweeping the center frequency of the demodulator (described below) in steps such as to cover the desired frequency range. Each period of time the receiver central frequency is changed until wide band transmit command signal is detected.

Optionally, tag 4 receiving the wide band transmit command signal is responding to the wide band transmit command signal with a response signal.

Tags 4 may be passive tags, which use energy transmitted to them to power themselves or may be active tags which are battery powered or powered by other power supplying means, such as for example a car battery or alternator. In an exemplary embodiment of the present invention, passive tags 4 receive the energy they use for transmission from reader 2. Alternatively or additionally, passive tags 4 receive their energy from a field generator separate from reader 2 and/or transmitting in a separate frequency band from the wide band transmit command signal of reader 2.

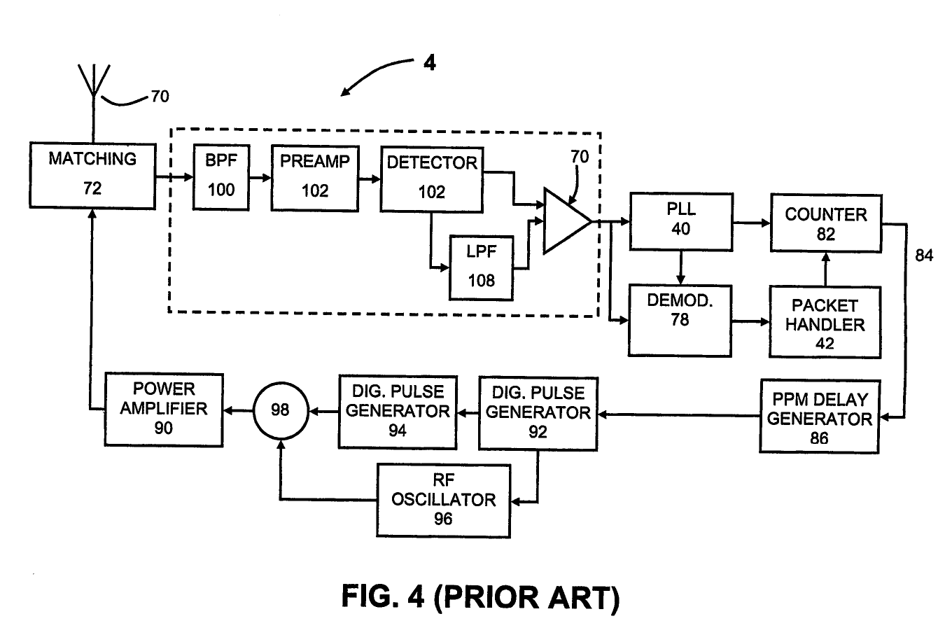

Referring now back to the drawings, FIG. 4 is illustrating a prior art schematic block diagram of an exemplary preferred embodiment of a tag 4, in accordance with an exemplary embodiment of the present invention. FIG. 4 was disclosed already in PCT application No. PCT/IL 03/00358, dated May 4, 2003, by the same inventor of the present invention. Tag 4 features following described primary components. An antenna 70 tuned to receive wide band transmit command signal. An optional matching network 72 performs impedance matching between the reception and/or transmission blocks of tag 4 and antenna 70, as is known in the art. An optional switch (not shown in FIG. 4) is used for alternatively connect a reception path or a transmission path to antenna 70. A pulse detector 74 identifies pulses 22 on wide band transmit command signal and provides a trigger signal responsive to each pulse 22. In an exemplary embodiment of the present invention, pulse detector 74 comprises a band pass filter (BPF) 100 which passes only frequencies used for the transmission from reader 2 to tags 4. A preamplifier 102 amplifies the signal from band pass filter (BPF) 100 and an energy detector 104 generates a signal whose voltage level represents the energy of the amplified signal. The output of detector 104 is compared in a comparator 106 to a low pass filtering of the signal from low pass filter (LPF) 108, in order to detect pulses 22. Optionally, the output of low pass filter (LPF) 108 is amplified such that the comparison is above a predefined noise level. It is noted that instead of low pass filter (LPF) 108 any other threshold adaptation unit may be used. For example, the signal from detector 104 may be provided to a peak detector which determines the peak height of each pulse. The reference to the comparator is then optionally taken as a certain percentage (for example, 50%) of the peak level rather than being taken from low pass filter (LPF) 108. Alternatively, any other circuitry is used to implement pulse detector 74. For example, pulse detector 74 may comprise an AC block capacitor and/or a constant threshold level to which the comparison is performed.

In the exemplary embodiment of the present invention, when tag 4 identifies pulses 22 of preamble portion 24 of a signal received by antenna 70, a demodulator 78 is activated, so as to demodulate the data content of the data portion 26 of the received signal. Optionally, demodulated bits from demodulator 78 are provided to a packet handler 80 of tag 4, which is adapted to determine the content of the received signals. If a received signal includes a wide band transmit command signal, packet handler 80 optionally generates a response signal.

Remaining components of tag 4 used for transmitting the response are described in the following step.

In Step (d) there is RF tag 4 receiving the wide band transmit command signal and transmitting, according to a predefined logic, at least one wide band response signal in synchronization with the received wide band transmit command signal.

After receiving a wide band transit command signal, tag 4 is deciding whether it should respond according to a predefined logic. Examples of a predefined logic to a wide band transmit command signal are: tag 4 should not answer to every wide band transmit command signal, tag 4 is analyzing the wide band transmit command signal and responds only to specific reader or readers, and the response of tag 4 depends on the specific receiving reader. The main difference between an addressed wide band transmit command signal and a wide band broadcast transmit command signal is that whenever tag 4 is receiving an addressed wide band transmit command signal, it is transmitting a wide band response signal only to an addressed wide band transmit command signal having the appropriate tag identification.

A large transmission range may require a relatively high power consumption and/or sophisticated hardware from tags 4. A large transmission range may be economical even with battery operated tags by using the method described below to reduce the power consumption of tags 4.

Tag 4 wide band response signal may contain data. Not depending if there is or there is no data in the wide band response signal, the tag 4 is transmitting a signal that allows reader 2 to detect the presence of a tag 4 and to measure its distance. In an exemplary embodiment of the present invention, for simplicity, the data content includes a predetermined sequence used by tag 4 in all its wide band response signals. Alternatively, the data content may include specific data customized to the specific received wide band transmit command signal, for example responding to a specific ID in the wide band transmit command signal (such that a plurality of readers 2 may be used without interference in the same vicinity) and/or stating a random delay applied to the wide band response signal by tag 4, as described below. In an alternative exemplary embodiment of the present invention, the data content of the signals transmitted by reader 2 and/or tags 4 are encrypted by using any known in the art method.

The wide band response signal of tag 4 to the wide band transmit command signal may be carried out by using one of many available methods, all of them featuring adding some time delay, or other means, to the wide band response signal in order to avoid deterministic collisions between a plurality of tags. In other words, assuring that the collisions are not persistent and therefore can be resolved by using iterations. For example: each tag 4 waits a pseudo-random period before beginning to transmit the wide band response signal in order to prevent occurrence of a collision, in case a plurality of tags 4 respond together. Optionally, in these embodiments, each tag 4 transmits to reader 2 the length of the delay period it waited before transmitting the wide band response signals. The length of the delay period is optionally transmitted to reader 2 encoded in the wide band response signal, as described below.

Alternatively, the length of the delay period is transmitted on a separate signal

Alternatively, the length of the random delay is in large steps relative to the possible delay values, so that the delay period may be removed by reader 2 from the measured delay, without knowledge of the length of the delay period.

Alternatively, some or all of tags 4 are adapted to transmit two or more wide band response signals with different random delay values applied to wide band transmit command signal. Optionally, each tag 4 determines randomly the number of wide band response signals it is to transmit. The number of wide band response signals transmitted by each tag 4 is optionally selected such that, on the average, an optimal number of wide band response signals are transmitted by all the responding tags 4, for example, 18% of the maximal possible number of wide band response signals.

Alternatively, each tag 4 responds on a channel selected randomly from a predetermined pool of channels. The channels may differ in their frequencies (for example, when using frequency division multiple access (FDMA)) and/or in their codes (for example, when using code division multiple access (CDMA)).

In an exemplary embodiment of the present invention, the wide band response signal carries the ID of the transmitting tag 4 so that reader 2 knows the identities of the responding tags 4. Alternatively, in order to simplify system 10, the wide band response signals are not encoded with the ID of the transmitting tag 4. This alternative may be used when tag 4 is receiving an addressed wide band transit command signal or when it is only necessary to locate a tag 4 in the vicinity of reader 2 and it is not important to know the identity of that tag 4. Optionally, in this alternative, reader 2 may query the responding tag 4, for example using the time delay on which the wide band response was received to identify the responding tag 4. Alternatively or additionally, in embodiments in which different tags 4 respond on different channels (for example, frequency channels, and code channels). The specific channel used by the tag 4 to transmit the wide band response signal is used to query tag 4.

Hereinafter three alternative exemplary embodiments of the wide band transmit command signal and/or wide band response signals according to the present invention:

In the first exemplary embodiment of wide band transit command signals and/or wide band response signals according to the present invention, the wide band transmit command signals and/or wide band response signals comprise pulse signals which include pulses separated by no-energy periods. Optionally, the no-energy periods between pulses of a signal are of a same predetermined duration, such that after tuning onto a first pulse of the signal, the receiver knows the timing of the rest of the pulses of the signal. The use of pulse signals enables the low power consumption of tags 4, as described below. In addition, the use of pulse signals enables the transmission of a plurality of wide band response signals on a single channel at overlapping times without interference. Pulses can be either base-band or pass-band, as disclosed above. In an exemplary embodiment of the invention, a transmission data rate of about 100 Kbit/sec is used, with a bandwidth of about 50 MHz centered at about 2440 MHz. The shape of the pulse may be simple, such as Gaussian shape for example. Alternatively, the shape of the pulse may be complicated with complex shape designed to decreased the peak to average ratio. Such complicated pulse has longer duration, e.g. 100 ns but has same bandwidth of 50 MHz As an example to a complicated pulse, is a pulse composed by a sequence of short pulses separated by short gap of few ns and modulated by a barker sequence having good autocorrelation.

In the second exemplary embodiment of wide band transmit command signals and/or wide band response signals according to the present invention, the wide band transmit command signals and wide band response signals feature direct sequence spread spectrum signals. In an exemplary embodiment of the invention, a transmission data rate of about 100 Kbit/sec is used, with a bandwidth of about 50 MHz, centered at 2440 MHz. Note that considering the error correcting code or other overhead the actual information data rate is lower than 100 Kbit/sec.

In the third exemplary embodiment of wide band transmit command signals and/or wide band response signals according to the present invention, the wide band transmit command signal and wide band response signals comprise other type of wide-band signals than described in the first two exemplary embodiments for achieving other advantages as interference rejection, frequency error rejection, better multi-path immunity and more.

Referring to FIG. 4 again, in generating the wide band response signal, packet handler 80 optionally determines a data content to be modulated onto the wide band response signal. In an alternative exemplary embodiment of the present invention, for simplicity, the data content includes a predetermined sequence used by tag 4 in all its wide band response signals. Alternatively, the data content may include specific data customized to the specific received wide band transmit command signal, for example responding to a specific identification in the wide band transmit command signal (such that a plurality of readers 2 may be used without interference in the same vicinity) and/or stating a random delay applied to the wide band response signal by tag 4, as described below. In another alternative exemplary embodiment of the present invention, the data content of the signals transmitted by reader 2 and/or tags 4 are encrypted using any method known in the art.

The transmission of the wide band response signal pulses may be timed by the received pulses 22 of wide band response period portion 28. In an exemplary embodiment of the present invention, for each received pulse 22 of wide band response period portion 28, a pulse of the wide band response signal is transmitted. For example, each tag 4 responding to the wide band transmit command signal transmits a pulse of its wide band response signal responsive to a pulse 22 of wide band response portion 28. Optionally, each tag 4 transmits all the pulses of a specific wide band response signal, a predetermined delay time after receiving the pulse 22 of portion 28. In an alternative exemplary embodiment of the present invention, the predetermined delay time is selected using a pseudo-random method, for each specific signal. Thus, the same delay is used in these embodiments for all the pulses of a single wide band response signal.

Referring to FIG. 4, in an exemplary embodiment of the present invention, in parallel to preparing the data content of the wide band response signal by packet handler 80, for each pulse 22 detected by pulse detector 74, a trigger signal designating the timing of a respective pulse is provided on a line 84. The preparation of the trigger signal on line 84 is described below.

In an exemplary embodiment of the present invention, in which the data content of the wide band response signal is modulated by changing the timing of its pulses, a pulse position modulation (PPM) delay generator 86 receives the trigger signal on line 84 and the data content of the wide band response signal a bit at a time. For each received trigger, delay generator 86 alters the timing of the trigger according to the value of the data bit currently provided, and passes the altered trigger to a pulse generator 88 which generates a respective pulse. The pulse is optionally amplified by a power amplifier 90 and transmitted on antenna 70. Alternatively, separate antennas may be used for reception and transmission.

Optionally, the wide band response signal is transmitted on the same channel as wide band transmit command signal, and the pulses of the wide band response signal are timed to be transmitted between pulses 22, so as not to be interfered by the wide band transmit command signal. Alternatively, tag 4 transmits the wide band response signals on a different channel.

Optionally, pulse position modulation (PPM) delay generator 86 adds an additional constant delay to allow for backward modulation (for example, 5 ns). Alternatively, a time modulation which does not require backward timing is used, for example, addition of 0 ns for ‘0’ and 10 ns for ‘1’. Alternatively, other apparatus arrangements are used for the modulation, allowing for inserting backward delays.

Referring in more detail to generating the trigger signal on line 84, In an exemplary embodiment of the present invention, tag 4 includes a phase locked loop (PLL) unit 76, which manages, based on an internal clock (not shown) of tag 4, a high rate internal timing signal at a higher rate than the rate of pulses 22. In an exemplary embodiment of the invention, the internal timing signal operates at a rate 100 times faster than pulses 22. Optionally, PLL unit 76 includes a division circuit (not shown) which produces a reduced-rate timing signal at the same rate as pulses 22. Optionally, a phase detector within PLL unit 76 compares the trigger signals of pulse detector 74 generated responsive to pulses 22 to the reduced-rate timing signal of PLL unit 76. According to the comparison of the phase detector, the timing of PLL unit 76 is corrected so as to synchronize to the timing of reader 2. Thus, the round trip delay timing measurements are not substantially affected by the fact that reader 2 and tag 4 have different clocks. In an alternative exemplary embodiment of the present invention, PLL unit 76 provides the reduced-rate timing signal to demodulator 78 which uses the reduced-rate timing signal in performing the demodulation, as is known in the art.

In an exemplary embodiment of the present invention, as mentioned above, for each wide band response signal, a random delay is selected, to prevent collisions with wide band response signals of other tags 4. A counter 82 optionally adds the random delay period to the trigger signal from pulse detector 74, so as to provide the trigger signal on line 84. In an alternative exemplary embodiment of the present invention, counter 84 receives from packet handler 80 an indication of the random delay period to be added to the trigger signal. Optionally, the indication of the random delay period is provided to counter 82 in the form of an integer number indicating a number of cycles of the high rate internal timing signal which are to form the random delay period. In an alternative exemplary embodiment of the present invention, the integer number is selected using a pseudo-random algorithm in the range of the number of cycles of the high rate internal timing signal included in the period between two pulses 22, for example, between 1 to 99. Optionally, a random delay period of 0 cycles is not used, as the internal operation delay of tag 4 would cause a delay to be added when the delay is not desired. In an alternative exemplary embodiment of the present invention, tags 4 have a low internal delay which is negligible relative to the intentionally added delay. Alternatively, tag 4 includes fast switching apparatus, such that the variable internal delay is negligible relative to the measurement accuracy of reader 2.

Alternatively, when the chances of a collision are very low and/or when other methods are used to prevent and/or resolve collisions, PLL unit 76 and counter 82 are not used and the trigger signals from pulse detector 74 are provided directly on line 84. In an exemplary embodiment of the present invention, in accordance with this alternative, reader 2 includes a PLL unit for other purposes, for example to aid in the reception of the wide band response signals and/or in the averaging of the pulse times of the wide band response signals.

Pulse generator 88 optionally comprises a digital pulse generator 92, which generates a short digital pulse, for example: 10 ns logic ‘1’. The short pulse is optionally provided to a shaping filter 94 which smoothes the pulse for transmission, as is known in the art. Shaping filter 94 optionally makes the pulse in the bandwidth suitable for transmission in the required band. Optionally, the shaping is performed without causing the pulses to have side lobes which may be interpreted as the pulses.

In an exemplary embodiment of the present invention, an RF oscillator 96 and a mixer 98 modulate the shaped pulse from shaping filter 94. It is noted that the shaped pulse duration is longer than the short digital pulse, for example, of about 50 ns. Optionally, RF oscillator 96 and mixer 98 operate for the entire duration of the shaped pulse. In an alternative exemplary embodiment of the present invention, the operation of RF oscillator 96 is determined by a control signal provided by digital pulse generator 92, together with the short pulse provided to shaping filter 94.

In an exemplary embodiment of the present invention, before tag 4 begins transmitting modulated pulses of the wide band response signal in synchronization with the wide band transmit command signal, tag 4 is transmitting, at the beginning of the response period, several (for example, 10) non-modulated pulses or modulated pulses with a sequence identical to all tags and known to the reader, during a second synchronization period of the PLL of tag 4. The object of this second synchronization period is to increase the look accuracy of the PLL. These non-modulated pulses optionally inform reader 2 of the forthcoming wide band response signal. These non-modulated pulses also optionally used in reader 2 for increasing the accuracy of estimating the number of responses to the wide band transmit command signal. Note that a collision between two tags is interpreted as a single tag response. Alternatively, the PLL synchronization period is carried out without actually transmitting the pulses.

Tag 4 can be programmed to respond only to a specific set of readers according to their reader ID. This can save the power of tag 4, improve security and reduce the traffic. Alternatively or additionally, tag 4 stop answering the wide band transmit command signal from a specific reader 2 after it responded to wide band transmit command signals from that specific reader a predetermined number of times in a predetermined duration. Responding to the specific reader 2 is resuming after either that predetermined duration past since last wide band response or the receive power has been changed by more that a predefined value relative to the power of the received signal to which tag 4 had responded. Tag 4 determines reader 2 identity by either using reader 2 ID, if presents in the signal received by tag 4, or by physical properties of the signal that identity reader 2, such as for example: carrier frequency or time slot. This mechanism is advantageous in two aspects: saving the power consumed by tag 4 when transmitting the wide band response signal, and reducing the traffic on the air, reducing interference to other tags that need to respond or to other wireless devices thereby reducing the collision probability.

In Step (e) there is reader 2 receiving the wide band response signal from RF tag 4, measuring the round trip delay and the amplitude of the received response signal.

Reader 2 is measuring the round trip delay (RTD) between the transmission of the wide band transmit command signal and the reception of the wide band response signal.

In order to acquire rough directional information, the antenna of device 6 the reader is a directional antenna, as disclosed above. The received signal amplitude of the first path in the multi-path by a directional antenna is a non-linear function of the angles between the main axes of directional antenna 8 to RF tag 4 direction. As a result, the relative amplitude of the first path in the multi-path to the maximum approximated value approximately defining a spatial angle that is indicating the direction from where the signal propagated with a right-left ambiguity. The received signal amplitude, preferably of the first path, is transferred to display controller 10 that is indicating the user about the relative amplitude of the received signal compared with the estimated maximum received signal. In order to find the transmitting RF tag 4, the user manually points device to the direction of maximum received signal amplitude.

In an exemplary embodiment of the present invention wherein the user is locating tag 4 in an area featuring obstacles, the maximum signal or total signal is measured (instead of the relative amplitude of the first path in the multi-path). Measuring maximum signal defining a spatial angle to tag 4 that may direct the user to go around some of that obstacles.

In the exemplary embodiment of the present invention wherein reader 2 is sending a wide band broadcast transmit command signal, reader 2 may receive at least one wide band response signal wherein that at least one wide band response signal received by reader 2 may include overlapping wide band response signals whenever it is including a plurality of wide band response signals transmitted by a plurality of tags 4. In that exemplary embodiment, reader 2 is detecting at least one response sequence included in that at least one wide band response signal received by reader 2, counting the approximate number of distinguishable responses to that wide band transmit command signal, and analyzing the wide band response signals transmitted by the authorized tags in order to determine the round trip delay (RTD). For each wide band response signal received by reader 2, reader 2 determines the round trip delay (LTD) between the transmission of the wide band transmit command signal and the reception of the wide band response signal. In an exemplary embodiment of the present invention, reader 2 is counting the number of valid tag responses using some validity checks methods, for example, using the CRC check. Alternatively, in case that a very large number of tags responses (hundreds to thousands) are expected, the collision rate is so high that the number of valid responses would be too low. An alternative method that is almost insensitive to the collisions, is detecting the presence of the non modulated, or modulated with predefined sequence, period of the tag response. The property of this section of the response is that accumulation of responses of several tags is usually not destructive.

In an exemplary embodiment of the present invention, reader 2 is adapted to have a distance resolution of between few meters to few centimeters. Optionally, signals of a bandwidth of about 50 MHz, or even about 100 MHz are used. In an exemplary embodiment of the invention, the transmitted signals are in the 2.4 GHz band.

In an exemplary embodiment of the present invention, the round trip delay is determined by subtracting a predetermined correction factor from the measured time between the transmission of the wide band transmit command signal and receiving the wide band response signals. The predetermined correction factor optionally compensates for a known delay of tags 4 between receiving the wide band transmit command signal and transmitting the wide band response signal and/or for the operation time of reader 2. In another alternative exemplary embodiment of the present invention, the same correction factor is used for all tags 4. Alternatively, different tags 4 have different predetermined correction factors and reader 2 optionally selects the factor to be used, from a pre-configured list or a hash function, according to the identity of the specific tag 4 and/or according to any other information known about tag 4 and/or received from the tag 4. The different correction factors may be due to different hardware structures of tags 4 and/or due to a purposeful different delay configured into different groups of tags 4 in order to reduce the chances of a collision between the plurality of wide band response signals transmitted by tags 4.

In an exemplary embodiment of the present invention, as mentioned above, tags 4 delay the transmission of the wide band response signal by a pseudo-random delay period in order to reduce the chances of a collision occurring. Alternatively or additionally to reducing the predetermined correction factor, in these embodiments, reader 2 subtracts the length of the random delay period from the measured time between the transmission of the wide band transit command signal and receiving the wide band response signals.

In an exemplary embodiment of the present invention, reader 2 does not operate any collision resolution method, as the chances of a collision are low and such resolution methods are not required.

In an exemplary embodiment of the present invention, there are reflections that cause the transmitted wide band response signal to travel along few paths to reader 2, known in the art as the ‘Multipath’ effect. The Multipath effect causes inaccuracy in the delay measurements since each of the paths has different delay. Some of the well known in the art methods for dealing with the Multipath effect are adequate to the present invention. In the preferred embodiment of the present invention, there is measuring the delay of the first Multipath component, which most probably related to the line of sight (LOS) path, and therefore reflects the true distance. There are several well known in the art techniques for measuring the first Multipath component. For example, taking the rising edge of the pulse signal as made from the first Multipath by synchronizing the transmit clock of tag 4 to the rising edge of the pulse. In another example, there is measuring in tag 4 the mean delay of all Multipath, and synchronizing the transmit clock of the tag 4 to the mean delay. One way to do this is to down-convert and sample the received signal into a signal processing circuit that correlates it with the transmitter pulse shape if the pulse shape is complex, and then take the envelope and compute the mean delay. Alternatively, such computation is carried in the frequency domain by averaging the phase difference between consecutive frequency samples. In reader 2, after receiving the transmission from tag 4, there is calculating the rising edge of the pulse by the digital signal processor (ASP), and compensating the difference between the mean and the rising edge. The just described algorithms for dealing with the Multipath effect may be implemented in reader 2, in the tag 4, or in both of them.

In an exemplary embodiment of the present invention, a controller reviews the received list of tag 4 IDs to determine whether a single ID appears twice. The multiple appearances of signals from a single tag 4, i.e., with a single ID, is generally due to multi-path reflections or if the tag transmitted several times as described below. Therefore, the second occurrence of the ID tag 4, i.e., with the longer delay, is removed from the list of responding tags 4.

Referring again to FIG. 3 showing a schematic block diagram illustrating an exemplary preferred embodiment of a reader 2, in accordance with an exemplary embodiment of the present invention, reception path 38 receives wide band response signals from tags 4, optionally through directional antenna 8, and provides baseband digital samples of the received signals to a DSP 40. Optionally, together with the signal samples, reception path 38 provides the reception time of each sample, which is used for synchronization of software of DSP 40 to the samples from analog to digital converter (A/D) 60.

Alternatively or additionally, the reception times of the samples are determined by DSP 40 from the order in which the samples are provided to DSP 40.

In an exemplary embodiment of the present invention, reception path 38 includes a down-converter 54, an RF oscillator 56, an automatic gain control (AGC) 58 and an A/D converter 60, as is known in the art. Optionally, reception path 38 further includes a buffer 62, which stores the samples until they are handled by DSP 40.

In an exemplary embodiment of the present invention, DSP 40 analyzes the samples, using methods known in the art, to determine the timing of received pulses. The received pulses are optionally organized according to their timing relative to the transmission of a nearest previous pulse 22. The received pulses following a single pulse 22 are generally due to respective different tags 4. In an alternative exemplary embodiment of the present invention, DSP 40 collects the pulses having similar delay from pulse 22 they follow and marks them as belonging to a single tag 4.

In an exemplary embodiment of the present invention, each collection of pulses belonging to a single tag 4 is examined to determine that it includes at least a predetermined number of received pulses. Optionally, the predetermined number of required pulses is a number that allows reconstructing the data content of the wide band response signal using error correction methods. In an exemplary embodiment of the invention, the predetermined number of required pulses is at least about ⅞ of the total number of pulses in wide band response signal.

DSP 40 is optionally calculating an average time delay for collected pulse groups including at least the predetermined number of pulses. Using the average time delay, DSP 40 Is extracting the modulated data from the collected pulse groups. The timing of the pulses are optionally corrected according to their modulation (in those embodiments in which delay modulation is used), for example by adding or subtracting 5 ns according to the bit carried by the pulse group. Thereafter, a second, more accurate, average is optionally calculated. Alternatively or additionally, before calculating the second average, pulses determined to be erroneous in the error detection are removed from consideration, as their timing may be incorrect, for example, due to multi-path reflections. Pulses determined to be erroneous in the error detection may be due to a false detection and/or may otherwise contribute erroneous timing values to the timing average. In an exemplary embodiment of the present invention, a validity check, for example a CRC check, is applied to the data of the wide band response signals, and only signals which pass the validity check are considered. The validity check and the error correction may be performed in separate steps or may be performed together in a single step.

By DSP 40 calculating an average time delay for collected pulse groups including at least the predetermined number of pulses, the precision of the round trip delay determination is increased relative to a single delay measurement. In an exemplary embodiment of the present invention, the pulse form of each received pulse is interpolated from the samples received from A/D converter 60, further enhancing the precision of the round trip delay determination.

In an exemplary embodiment of the present invention, the random delay purposely added by the transmitting tag 4 is determined from the demodulated data and subtracted from the average delay, so as to receive the delay which is due to the traveling distance. Alternatively or additionally, the random delay values are provided in steps larger than the largest round trip delay of the signals, such that the random delay is subtracted by DSP 40 without relating to the contents of the signal. For example, if the range of system 10 is limited to 15 meters, the longest transmission time of signals is about 100 ns. Optionally, for this example, the random delay is in steps of 250 ns. DSP 40 then relates only to modulo of the division of the measured propagation time divided by 250 ns.

Further alternatively, a predetermined delay is subtracted from the average delay. The ID of the transmitting data is optionally also extracted from the demodulated data. The extracted ID and the delay due to the signal traveling distance are optionally transferred to a display controller 10 which determines whether to relate to tag 4 or whether tag 4 should be ignored.

Alternatively to having a separate display controller 10 and DSP 40, a single processor may perform the tasks of both DSP 40 and display controller 10. Further alternatively, other distributions of the tasks between DSP 40 and display controller 10 may be used.

In an alternative exemplary embodiment of the reception path 38 in reader 2 of FIG. 3, reception path 38 including: (a) a pulse detector, for example having the same structure as pulse detector 74 from FIG. 4 described above, which identifies the pulses in the received signals. (b) A counter provides timing counts at a relatively high rate, for example 200 MHz. (c) For each received pulse, the time at which the pulse was received (for example, the rising or falling edge of the pulse), is stored in buffer 62. In this alternative exemplary embodiment, the size of buffer 62 may be substantially smaller than in the embodiment of FIG. 3, as only the locations of the pulses need be stored. In addition, the relatively complex oscillator 56, down converter 54, AGC 58 and A/D 60 are not required. In this alternative exemplary embodiment, DSP 40 does not need to determine the timings of the pulses as described above, as this is performed by the pulse detector.

It is well understood that it is possible to separate step of distance measurement and tag 4 identification to two separate steps of distance measurement and tag 4 identification and/or use another transaction or a separate protocol for doing so without affecting the scope of the present invention.

In optional step (f) there is reducing the collision probability between a plurality of tags 4.

Reader 2 is testing a predefined statistical criterion indicative of the collision probability between the tag wide band response signals and according to the result of this test there is transmitting by reader 2 at least one additional wide band transmit command signal, and at least one tag 4 may transmit a wide band response signal according to a predefined logic.

In optional sub-step 1 of step (f) there is repeating step (f) until the number of responses received by reader 2 in response to a wide band transmit command signal is less than the predefined statistical criterion.

In optional sub-step 2 of step (f) there is repeating step (f) and sub-step 1 of step (f) additional number of times for reducing the overall collision probability.

Since the estimated number of responses can indicate about the collision probability, in an exemplary embodiment of the present invention, according to a predetermined statistical criterion applied by reader 2 on the estimated number of responses received by reader 2 in response to a wide band transmit command signal, reader 2 transmit a second wide band transmit command signal or a plurality of wide band transmit command signals 20 immediately after the first wide band transmit command signal.

In optional step (g) there is reader 2 performing a task with tag 4.

Moreover, reader 2 may compare a predefined threshold to the measured round trip delay, and perform a task with tag having round trip delay that is passing the threshold test

The determined round trip delay is optionally compared to an upper threshold value. For example, if the round trip delay is greater than the upper threshold value, the respective wide band response signal is ignored. The remaining wide band response signals (not ignored) after the comparison, are used by reader 2 in performing its specific application as described below.

It is noted that the threshold may be stated in terms of delay time or may be stated as a distance, in which case the time is converted into a distance before the comparison.

Moreover to comparing to an upper threshold, the determined round trip delay may be compared to a lower threshold in order to ignore tags too close to reader 2. Moreover, a plurality of allowed and/or prohibited ranges may be defined and the round trip delay is compared to values corresponding to these ranges.

Optionally, a user may configure reader 2 with the ranges and/or the behaviors for the ranges. In an alternative exemplary embodiment of the present invention, reader 2 has a user interface that allows configuration of the ranges. Alternatively or additionally, reader 2 is associated with one or more host computers through which the configuration is performed. In an alternative exemplary embodiment of the present invention, the configuration may depend on one or more external parameters, such as time, date, visibility conditions and/or temperature. For example, different ranges may be used during day and night.

In Step (h) there is display controller 10 receiving from reader 2 the measured round trip delay and amplitude of the received response signal, and displaying that information on a display device 12.

In order to acquire directional information, the antenna of the reader is a directional antenna, receiving signal amplitude proportional to the angles between the main axes of directional antenna 8 to RF tag 4 location, and as a result, defining a spatial angle that is indicating the direction from where the signal propagated. The received signal amplitude is transferred to the display controller that is indicating the user about the relative amplitude of the received signal compared with the estimated maximum received signal amplitude as function of the measured distance between the device 2 to the transmitting RF tag. In order to find the transmitting RF tag, the user manually points the locator device to the direction of maximum received signal amplitude.

The approximate distance and indication of the relative signal as a function of the angle between the axes of directional antenna 8 and RF tag 4 position make the task of locating tag 4 relatively easy.

Display device 12 can indicate angle and distance to RF tag 4 by using many various ways, all of them fall within the spirit and broad scope of the present invention. An exemplary display device 12 having few LEDs, each for difference distance range or seven-segment display that is indicating the distance in meters or other suitable units. The signal amplitude information which is used to direct the antenna will be conveyed using an audio tone which its pitch or volume changes relative to the amplitude. In alternative exemplary display device 12, both angle and distance are conveyed using LEDs, seven-segment displays or LCD displays. In another alternative exemplary display device 12, there is only audio indication wherein the pitch is relative to amplitude and volume relative to distance, or vice versa. In another alternative exemplary display device 12, both angle and distance are given visually and audio.

In an exemplary embodiment of the present invention, the amplitude of the first Multipath component is forwarded to the display device. In an alternative exemplary embodiment of the present invention, a total amplitude of all the received Multipath components or other combinations of the received amplitudes is forwarded to the display device.

Thus, it is understood from the embodiments of the invention herein described and illustrated, above, that the method and system for RF tag locating, of the present invention, are neither anticipated or obviously derived from the prior art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

While the invention has been described in conjunction with specific embodiments and examples thereof, it is evident that many alternatives, modifications and variations will be apparent to those skilled in the art Accordingly, it is intended to embrace all such alternatives, modifications and variations that fall within the spirit and broad scope of the appended claims. For example, device 6, with the appropriate modifications, may be used by a human being, may be used by an animal, or may be used by an electronic system, such as a robot tracking automatically some object, or directing a camera to a required object, and so on. Whenever device 6 is used by an electronic system, the measured round trip delay and amplitude of the at least one received response signal is delivered to the operating system of that electronic system and not to a display device (although it may be delivered to a display device too whenever needed).

Moreover, although the above description relates to using pulse signals for communicating between reader 2 and tags 4, other types of signals may be used, in accordance with some embodiments of the invention. For example, in an exemplary embodiment of the present invention, various spread spectrum transmission methods may be used, including direct sequence (DS), frequency-hopping (FH) and multi-carrier CDMA (MC-CDMA). Moreover, other transmission methods may be used with appropriate transceiver, such as chirp signals and/or short pulses or long pulses with arbitrary shapes with or without time hopping (TH).

Moreover, different sequences may be defined for different readers 2. Thus, when a plurality of readers operate in a close region, a collision corrupting one pulse of a wide band response signal does not usually prevent reader 2 from demodulating the wide band response signal.

Moreover, it is possible to use a preamble signal or any other appropriate special signal for activating tag 4 that is in sleep mode. The preamble signal can be narrowband or broadband.

Device 6 may be used for substantially any RF tag locating. In addition, Device 6 may be used for security purposes, for example by locating non-authorized people or objects. It is noted that device 6 may include a plurality of readers 2 in different locations monitoring overlapping or non-overlapping areas.

The term tag 4 used in the above description relates to substantially any unit which is attached to an object (including vehicles, plants, animals and humans) for RF identification of the object or enabling the location of the object. The tag 4 may be attached to the object using any method known in the art including physical coupling, implanting, magnetism, and other association methods even without direct contact. The tag 4 may be attached to the object after its production or during production. The tag 4 may be very small (e.g., for small objects) or may be relatively large (e.g., for vehicles).

It is to be understood that using either true random or good pseudo-random number generator in the embodiment of any of the components of the present invention has no noticeable influence on the performance of system 10. Therefore writing “random” in this document should be interpreted as either random or pseudo-random and vice versa.

It should be appreciated that the above described description of methods and device are to be interpreted as including device for carrying out the methods and methods of using the device.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof it is evident that many alternatives, modifications and variations will be apparent to those skilled in the art. Accordingly, it is intended to embrace all such alternatives, modifications and variations that fall within the spirit and broad scope of the appended claims.

1. A method for locating at least one radio frequency (RF) tag, the method comprising the steps of:
(a) providing a locating device having a means for identifying said at least one RF tag,
(b) transmitting a directional transmit command signal to said at least one RF tag by using said locating device, wherein said locating device includes a directional antenna,
(c) said at least one RF tag waiting to receive said transmit command signal,
(d) upon receiving said transmit command signal, transmitting by said at least one RF tag, at least one response signal in synchronization with said transmit command signal, and
(e) receiving said at least one response signal, by said locating device, measuring round trip delay and amplitude of said at least one received response signal.

2. The method of claim 1, wherein said directional transmit command signal is a directional wide band transmit command signal and said response signal is a wide band response signal.

3. The method of claim 2, further comprising the step of:
(f) converting said round trip delay and amplitude to distance and directional information and displaying said distance and directional information
(g) using the displayed information for locating the at least one RF tag.

4. The method of claim 2, wherein said means for identifying said at least one RF tag is selected from the group consisting of: identification number, serial numbers, all available RF tags, selecting some of said all available RF tags by using input means, a predefined group of RF tags, and features of said at least one RF tag.

5. The method of claim 1, wherein said amplitude is selected from the group consisting of: amplitude of the first Multipath component, an amplitude of a predefined component, and an amplitude resulting from applying a function on measured Multipath components.

6. The method of claim 2, wherein power of said directional transmit command signal can be configured by a user.

7. The method of claim 2, wherein said means for identifying said at least one RF tag includes a device selected from the group consisting of: numeric pad, optical reader, RF receiver, preprogrammed memory.

8. The method of claim 2, wherein said transmitting, by said at least one RF tag, said wide band response signal includes: transmitting, by said at least one RF tag, according to a predefined logic, said wide band response signal in synchronization with said wide band transmit command signal.

9. The method of claim 2, wherein said wide band response signal is transmitted on the same channel of said wide band transmit command signal.

10. The method of claim 2, wherein the measured round trip delay of said at least one received wide band response signal is determined by subtracting a predetermined correction factor from the measured time between the transmission of said wide band transmit command signal and receiving of said wide band response signal, whereby said predetermined correction factor compensates for a predefined time delay of said at least one RF tag between receiving said wide band transmit command signal and transmitting said wide band response signal, and a predefined time delay of said locating device operation.

11. The method of claim 2, wherein said locating device includes a means for overcoming a Multipath effect.

12. The method of claim 11, wherein said means for overcoming a Multipath effect include measuring the delay of the first Multipath component.

13. The method of claim 2, wherein said wide band transmit command signals and wide band response signals includes pulse signals having pulses separated by no-energy periods.

14. The method of claim 13, wherein said pulse signal is composed of a sequence of modulated short pulses.

15. The method of claim 2, wherein said wide band transmit command signals and wide band response signals featuring a bandwidth of about 500 MHz centered between 3 to 10 GHz.

16. The method of claim 2, wherein said locating device increases repetition frequency of said at least one additional directional transmit command signal when detecting fast changes in received power of said at least one response signal, and reduces the repetition frequency of said at least one additional directional transmit command signal when detecting stable power of said at least one response signal.

17. A device for locating at least one RF tag, the device comprising:
(a) a directional antenna, (b) a reader, (c) a display controller, and (d) a display device, wherein said reader transmits a message to said at least one RF tag by using said directional antenna, and said at least one RF tag transmits an answer in synchronization with said reader, and said reader receives said answer from said at least one RF tag and measures a round trip delay and an amplitude of the received radio signal, and said reader forwards said measured round trip delay and said amplitude to said display controller controlling said display device.

18. The device of claim 17 wherein said display controller and said display device are implemented in an integrated display and control device.

19. The device of claim 17, wherein said directional antenna can be folded whenever said locating device is not in use.

20. The device of claim 17 adapted to be used by a user to manually locate at least one tag, wherein a user receives feedback regarding said at least one RF tag location by means selected from the group consisting of audio means, visual means and audio and visual means.

21. The device of claim 17 wherein said device is used by an electronic system and said measured round trip delay and said amplitude are delivered to an operating system of said electronic system.

22. The device of claim 17 wherein said directional antenna is a Monopulse type antenna including at least two spatially separated directional antennas.
